(19) United States
(12) Patent Application Publication
(10) Pub. No.: US 2005/0158490 A1
(43) Pub. Date: Jul. 21, 2005

(54) Multi-color bottle blank or container and the method for making it

(76) Inventor: Ta-Shan Huang, Jen-Wu Hsiang (TW)

Correspondence Address: CHARLES E. BAXLEY, ESQ., 90 JOHN STREET, THIRD FLOOR, NEW YORK, NY, 10038, US

(21) Appl. No.: 10/763,150

(22) Filed: Jan. 21, 2004

(51) Int. Cl. B29C 49/06; B29C 49/22

(52) U.S. Cl. 428/34.1; 264/255; 264/247; 264/535; 264/537; 264/513

(57) ABSTRACT

A multi-color bottle blank includes a first bottle blank portion, and a second bottle blank portion mounted on a surface of the first bottle blank portion and having a color different from that of the first bottle blank portion thus, the second bottle blank portion is mounted on the surface of the first bottle blank portion before the first bottle blank portion is fully cooled, so that the first bottle blank portion and the second bottle blank portion having different colors are combined with each other exactly and completely to form a multi-color bottle blank having a rigid and stable structure.

### BACKGROUND OF THE INVENTION

1. Field of the Invention

The present invention relates to a multi-color bottle blank or a multi-color container, wherein the first bottle blank portion is integrally combined with the second bottle blank portion exactly and completely to form a multi-color bottle blank having a rigid and stable structure.

2. Description of the Related Art

A conventional plastic container is made by a bottle blank. The bottle blank is initially baked and heated. Then, the bottle blank is placed into a die to perform a blowing expansion process, thereby expanding the volume of the bottle blank to form the plastic container having a larger volume. The bottle blank is made by injecting a melted plastic material into a mold cavity of a die. Then, the melted plastic material is cooled rapidly, so that the temperature is smaller than the crystalline temperature of the plastic material, thereby forming the bottle blank.

However, two bottle blanks of different colors are not combined easily. In general, plastic materials of different colors usually have different heat-absorbing and thermal expansion coefficients, so that when two bottle blanks of different colors are combined, the interface of the two bottle blanks has a weakened bonding strength, so that the interface of the two bottle blanks is easily cracked or broken during the blowing expansion process.

### SUMMARY OF THE INVENTION

The primary objective of the present invention is to provide a multi-color bottle blank and a multi-color container.

Another objective of the present invention is to provide a method for making a multi-color bottle blank.

A further objective of the present invention is to provide a method for making a multi-color bottle blank, wherein the second bottle blank portion is formed before the first bottle blank portion is fully cooled, so that the first bottle blank portion is integrally combined with the second bottle blank portion exactly and completely to form a multi-color bottle blank having a rigid and stable structure.

A further objective of the present invention is to provide a method for making a multi-color container.

A further objective of the present invention is to provide a method for making a multi-color container, wherein the blowing expansion device has an elongated shape and is deeply extended into the multi-color bottle blank, so that when the air is blown outward from the blowing expansion device, the expansion force is applied on the inner face of the multi-color bottle blank evenly, so as to expand the multi-color bottle blank outward stably and completely, thereby forming a multi-color container having a rigid and stable structure.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for making a multi-color bottle blank in accordance with the preferred embodiment of the present invention;

FIG. 2 is a partially cut-away perspective cross-sectional view of a first bottle blank portion in accordance with the preferred embodiment of the present invention;

FIG. 3 is a perspective view of the first bottle blank portion as shown in FIG. 2;

FIG. 4 is a partially cut-away perspective cross-sectional view of a second bottle blank portion in accordance with the preferred embodiment of the present invention;

FIG. 5 is a perspective view of the second bottle blank portion as shown in FIG. 4;

FIG. 6 is a flow chart of a method for making a multi-color container in accordance with the preferred embodiment of the present invention,

FIG. 7 is a plan cross-sectional view of a multi-color container blank in accordance with the preferred embodiment of the present invention; and

FIG. 8 is a perspective view of the multi-color container in accordance with the preferred embodiment of the present invention.

### DETAILED DESCRIPTION OF THE INVENTION

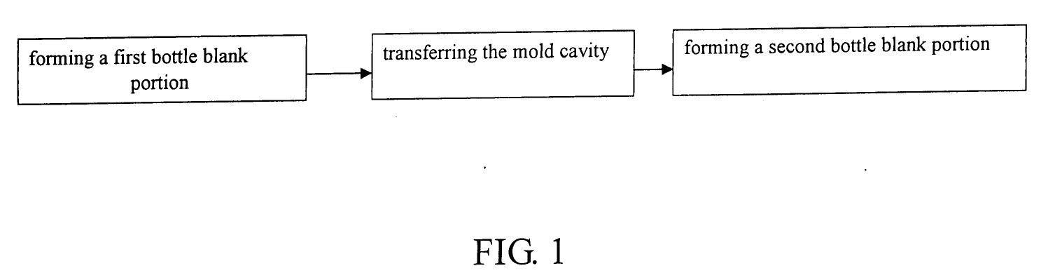

Referring to the drawings and initially to FIG. 1, a method for making a multi-color bottle blank in accordance with the preferred embodiment of the present invention comprises a first step 10 of forming a first bottle blank portion, a second step 30 of transferring the mold cavity, and a third step 40 of forming a second bottle blank portion.

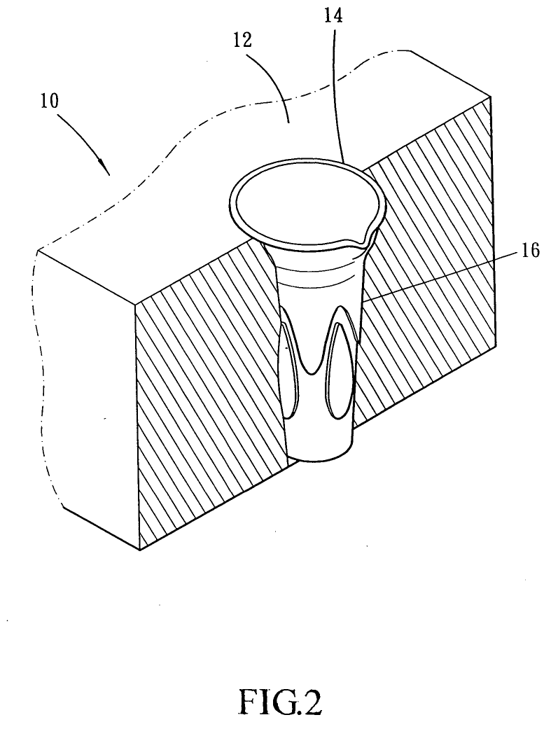

Referring to FIG. 2, the first step 10 includes injecting a first melted plastic material into a first mold cavity 14 of a first die 12. After the first melted material is cured, the first melted material forms a first bottle blank portion 16. Preferably, the optimum temperature for forming the first bottle blank portion 16 is set at about 200° C. to 270° C. during the injection molding process.

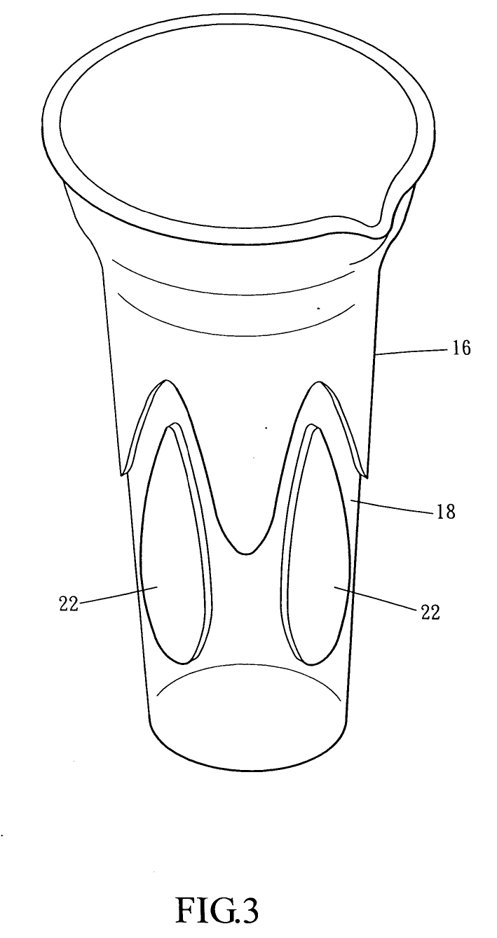

Referring to FIG. 3, the first bottle blank portion 16 is transparent and has a surface formed with a space 18. The space 18 is recessed in the surface of the first bottle blank portion 16 and has a periphery formed with a plurality of protruding portions 22 which are arranged in the space 18. In addition, the space 18 is extended through a peripheral length of the surface of the first bottle blank portion 16.

Referring to FIGS. 1, 2 and 4, the second step 30 includes transferring the first bottle blank portion 16 that is not fully cooled in the first mold cavity 14 of the first die 12 into a second mold cavity 34 of a second die 32. Preferably, the optimum temperature of the first bottle blank portion 16 is set at about 60° C. to 70° C. during the transferring process of the second step 30.

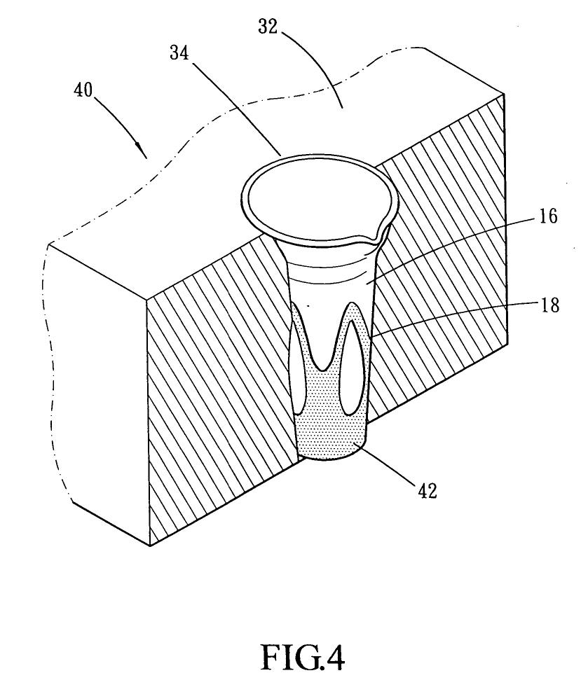

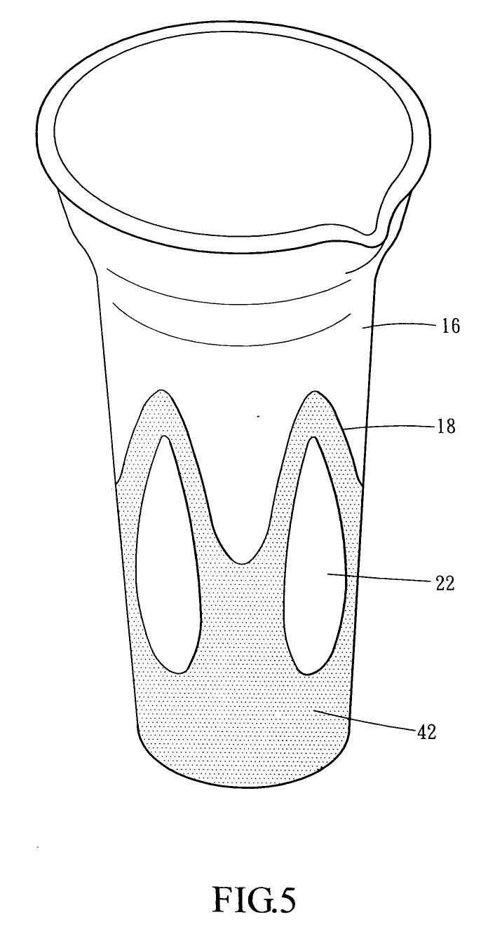

Referring to FIGS. 4 and 5, the third step 40 includes injecting a second melted plastic material into the second mold cavity 34 of the second die 32, so that the second melted material is integrally combined with the first bottle blank portion 16 that is not fully cooled. Preferably, the second melted material is filled with the space 18 of the first bottle blank portion 16 and flush with the surface of the first bottle blank portion 16. After the second melted material is cured, the second melted material forms a second bottle blank portion 42.

In such a manner, the first bottle blank portion 16 and the second bottle blank portion 42 have different colors. In addition, plastic materials of different colors usually have different heat-absorbing and thermal expansion coefficients. Thus, when the second bottle blank portion 42 is formed before the first bottle blank portion 16 is fully cooled, the first bottle blank portion 16 is combined with the second bottle blank portion 42 exactly to form a multi-color bottle blank having a rigid and stable structure. In addition, the combination face of the first bottle blank portion 16 and the second bottle blank portion 42 will not be broken after the multi-color bottle blank is cooled.

Preferably, the optimum temperature for forming the second bottle blank portion 42 is set at about 200° C. to 270° C. during the injection molding process. In the second step 30, the first bottle blank portion 16 is transferred from the first mold cavity 14 of the first die 12 to the second mold cavity 34 of the second die 32. In practice, it is designed that the first mold cavity 14 and the second mold cavity 34 are made in the same die which includes two male molds and two female molds. Thus, the distance of movement of the first bottle blank portion 16 is reduced, thereby facilitating control of the temperature of the first bottle blank portion 16, and thereby saving time of movement of the first bottle blank portion 16.

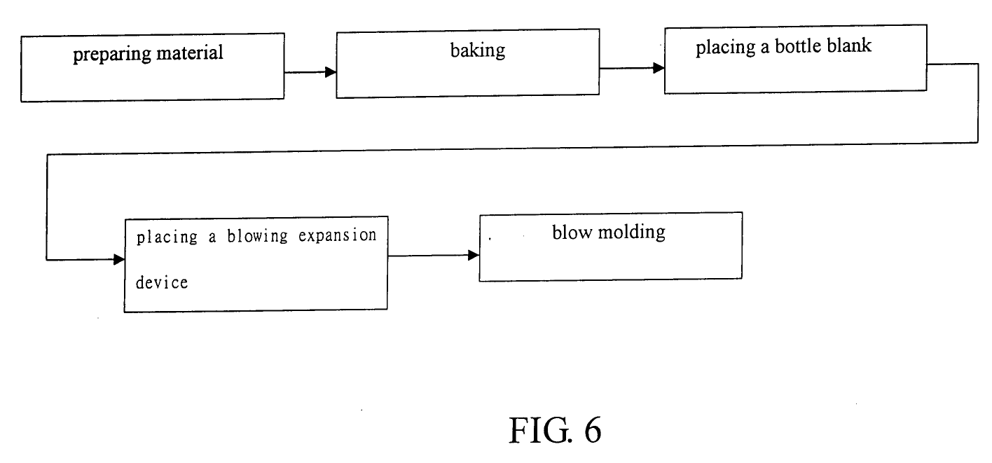

Referring to FIG. 6, a method for making a multi-color container in accordance with the preferred embodiment of the present invention comprises a first step 50 of preparing material, a second step 60 of baking, a third step 70 of placing a bottle blank, a fourth step 80 of placing a blowing expansion device, and a fifth step 90 of blow molding.

The first step 50 includes preparing a multi-color bottle blank as shown in FIG. 5.

The second step 60 includes baking the multi-color bottle blank at a preset temperature to soften the multi-color bottle blank. Each colored material has a different softening formed temperature. Thus, the baking temperature is determined according to the average value of the heat-absorbing values and softened temperature values of the multiple color materials. In the preferred embodiment of the present invention, the baking temperature is optimally set at about 150° C. to 170° C. A thermal sensor (not shown) is preferably extended into the multi-color bottle blank to monitor the temperature exactly.

The third step 70 includes placing the softened multi-color bottle blank into a die.

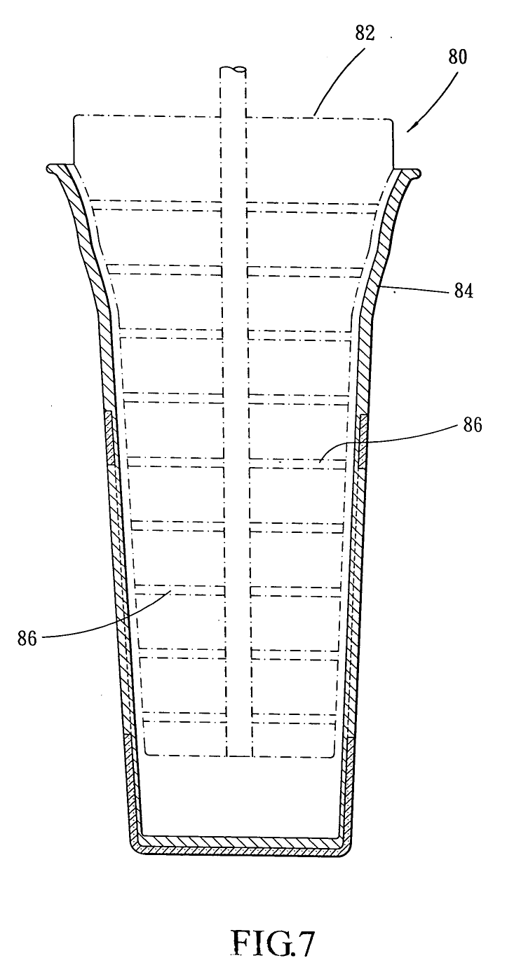

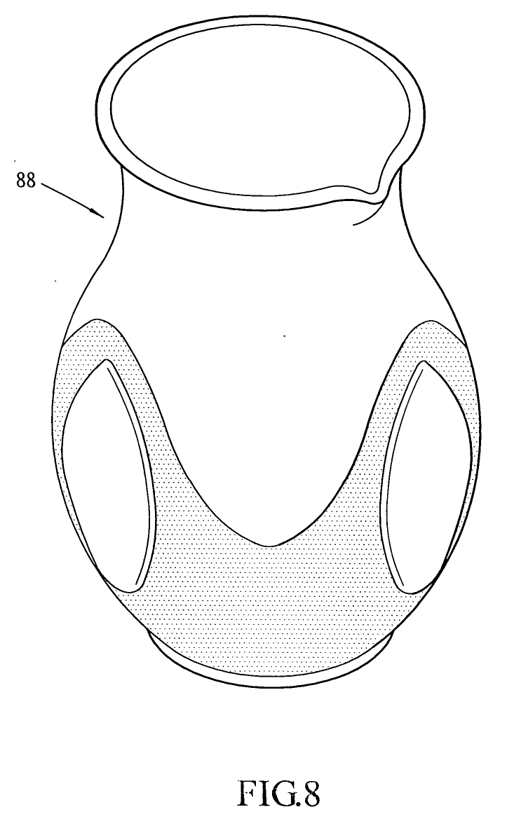

Referring to FIGS. 7 and 8, the fourth step 80 includes placing an elongated blowing expansion device 82 into the softened multi-color bottle blank 84, with a bottom of the blowing expansion device 82 being located adjacent to the bottom of the multi-color bottle blank 84. Preferably, the distance between the bottom of the blowing expansion device 82 and the bottom of the multi-color bottle blank 84 is about one fifth to one fourth of the height of the multi-color bottle blank 84.

The fifth step 90 includes blowing air outward from the blowing expansion device 82 and filling the air into the multi-color bottle blank 84, so that the multi-color bottle blank 84 is expanded with the blowing expansion device 82 simultaneously.

Preferably, the blowing expansion device 82 has a surface formed with a plurality of air vents 86, and the blowing expansion device 82 is deeply extended into the multi-color bottle blank 84, so that when the air is blown outward from the blowing expansion device 82, the expansion force is applied on the inner face of the multi-color bottle blank 84 evenly, so as to expand the multi-color bottle blank 84 outward stably and completely, thereby forming a multi-color container 88 as shown in FIG. 8.

In conclusion, the second bottle blank portion 42 is formed before the first bottle blank portion 16 is fully cooled, so that the first bottle blank portion 16 is integrally combined with the second bottle blank portion 42 exactly and completely to form a multi-color bottle blank having a rigid and stable structure. In other words, the temperature control is the primary factor during the forming process.

In addition, the blowing expansion device 82 has an elongated shape and is deeply extended into the multi-color bottle blank 84, so that when the air is blown outward from the blowing expansion device 82, the expansion force is applied on the inner face of the multi-color bottle blank 84 evenly, so as to expand the multi-color bottle blank 84 outward stably and completely, thereby forming a multi-color container 88 having a rigid and stable structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for making a multi-color bottle blank, comprising:
a first step including injecting a first melted material into a first mold cavity to form a first bottle blank portion;
a second step including transferring the first bottle blank portion that is not fully cooled in the first mold cavity into a second mold cavity; and
a third step including injecting a second melted material into the second mold cavity, so that the second melted material is integrally combined with the first bottle blank portion that is not fully cooled to form a second bottle blank portion, wherein:
the first bottle blank portion and the second bottle blank portion having different colors are combined with each other fully and exactly to form a multi-color bottle blank.

2. The method in accordance with claim 1, wherein the optimum temperature for forming the first bottle blank portion is optimally from 200° C. to 270° C.

3. The method in accordance with claim 1, wherein the optimum temperature of the first bottle blank portion is optimally from 60° C. to 70° C. during the transferring process of the second step.

4. The method in accordance with claim 1, wherein the optimum temperature for forming the second bottle blank portion is optimally from 200° C. to 270° C.

5. The method in accordance with claim 1, wherein the first mold cavity and the second mold cavity are located in the same die.

6. The method in accordance with claim 1, wherein the first mold cavity and the second mold cavity are located in two different dies.

7. A method for making a multi-color container, comprising:
a first step including preparing a multi-color bottle blank;
a second step including baking the multi-color bottle blank at a preset temperature to soften the multi-color bottle blank;
a third step including placing the softened multi-color bottle blank into a die;
a fourth step including placing an elongated blowing expansion device into the softened multi-color bottle blank, with a bottom of the blowing expansion device being located adjacent to a bottom of the multi-color bottle blank; and
a fifth step including blowing air outward from the blowing expansion device and filling the air into the multi-color bottle blank, so that the multi-color bottle blank is expanded with the blowing expansion device simultaneously, wherein:
the blowing expansion device is extended into the multi-color bottle blank, so that when the air is blown outward from the blowing expansion device, an expansion force is applied on an inner face of the multi-color bottle blank evenly, so as to expand the multi-color bottle blank outward stably and completely, thereby forming a multi-color container.

8. The method in accordance with claim 7, wherein the distance between the bottom of the blowing expansion device and the bottom of the multi-color bottle blank is about one fifth to one fourth of the height of the multi-color bottle blank.

9. The method in accordance with claim 7, wherein the preset baking temperature in the second step is determined according to an average value of the softened temperature values of multiple color materials.

10. The method in accordance with claim 7, wherein the preset baking temperature in the second step is optimally from 150° C. to 170° C.

11. The method in accordance with claim 7, wherein the blowing expansion device has a surface formed with a plurality of air vents.

12. A multi-color bottle blank, comprising:
a first bottle blank portion; and
a second bottle blank portion mounted on a surface of the first bottle blank portion and having a color different from that of the first bottle blank portion, wherein:
the second bottle blank portion is mounted on the surge of the first bottle blank portion before the first bottle blank portion is fully cooled, so that the first bottle blank portion and the second bottle blank portion having different colors are integrally combined with each other.

13. The multi-color bottle blank in accordance with claim 12, wherein the first bottle blank portion is transparent.

14. The multi-color bottle blank in accordance with claim 12, wherein the first bottle blank portion has a surface formed with a space, and the second bottle blank portion is filled with the space of the first bottle blank portion and flush with the surface of the first bottle blank portion.

15. The multi-color bottle blank in accordance with claim 12, wherein the space has a periphery formed with a plurality of protruding portions which are arranged in the space.

16. The multi-color bottle blank in accordance with claim 12, wherein the space is extended through a peripheral length of the surface of the first bottle blank portion.
